(19) United States
(12) Patent Application Publication
(10) Pub. No.: US 2010/0257826 A1
(43) Pub. Date: Oct. 14, 2010

(54) Dust Collector

(76) Inventor: Kun-Yen Lin, Daya Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/822,315

(22) Filed: Jun. 24, 2010

Related U.S. Application Data
(63) Continuation-in-part of application No. 12/055,897, filed on Mar. 26, 2008.

(51) Int. Cl. B01D 50/00

(52) U.S. Cl. 55/337

(57) ABSTRACT

A dust collector includes a separating chamber, an impeller, a motor, a duct and at least two filters. The separating chamber includes a cyclone barrel including a chamber, and at least two air flow outlets. The separating chamber also includes an intake including a first body including a pipe, and a second body connected to and disposed under the first body. The impeller is driven by the motor and the operational movement of the impellor induces dust particles into the intake through the pipe and creates an air curtain extending from the duct, and an eddying air stream separating the dust particles into larger dust particles and smaller dust particles and discharging the larger dust particles from the second body and discharging smaller dust particles from the at least two air flow outlets and thereafter into the at least two filters.

### CROSS REFERENCE

The present application is a continuation-in-part application of U.S. patent application Ser. No. 12/055,897, now abandoned, filed on Mar. 26, 2008, of which the entire disclosure is incorporated herein.

### BACKGROUND OF THE INVENTION

1. Field of the Invention

The present invention relates to a dust collector and, particularly to a dust collector including at least two air flow outlets disposed in particular orientations for preventing dust particles clogging their way of travel in the dust collector. More particularly, the dust collector includes a mechanism that separates dust particles into larger dust particles and smaller dust particles.

2. Description of the Related Art

Dust collectors are usually equipped in the works where dust particles are generated and are used to collect dust particles lest dust particles float everywhere and pollute the ambient. For example, when a lumber is sawed into pieces or fabricated into a specified shape in a wood mill, a great amount of wood debris and wood dust particles are generated. The floating wood debris and wood particles will contaminate the ambient and harm the worker's health if they inhale the debris and particles.

U.S. Pat. No. 7,550,021 discloses a dust collection system including an impeller that provides for an air stream that is adapted to drive dust particles to a cyclone barrel portion, and the cyclone barrel portion causes dust particles to fall into a cyclone chamber seated thereunder. Moreover, the system includes a filter disposed above the cyclone barrel portion to filter out the remaining microscopic dust particles from the air stream and return cleaned filtered air to the ambient. However, a problem that the system suffers is that it can not effectively separate dust particles into larger dust particles and smaller dust particles. All dust particles tend to move into the filter because the air stream substantially flows upward towards the filter and into the ambient due to negative-pressure effect. Another problem is that dust particles in the filter are liable to fall down into the cyclone chamber when the system is idle. Additionally, there is still a desire to provide a dust collector in which dust particles therein are prevented from clogging their way of travel.

The present invention is, therefore, intended to obviate or at least alleviate the problems encountered in the prior art.

### SUMMARY OF THE INVENTION

According to the present invention, a dust collector includes a separating chamber including a cyclone barrel which includes a chamber defining a space, and at least two air flow outlets extending tangentially from an outer peripheral wall of the chamber, a hollow intake including a first body connected to and disposed under the cyclone barrel and including a first compartment extending longitudinally therethrough and a hollow pipe extending tangentially from a peripheral wall of the first body, and a second body connected to and disposed under the first body and including a second compartment extending longitudinally therethrough. Moreover, the dust collector includes an impeller mounted in the chamber of cyclone barrel and including a radially extended fin rotated about an axis upon the operation thereof, a motor mounted above the cyclone barrel and connected to the impeller for driving the impeller, a duct connected to a bottom side of the cyclone barrel and disposed within the first compartment of the first body of the intake and including a third compartment extending longitudinally therethrough, and at least two filters connected to the at least two air flow outlets, respectively.

Furthermore, the space of cyclone barrel, the first compartment of the first body of the intake, and the second compartment of cyclone chamber communicate with one another. Additionally, the operational movement of the impellor induces dust particles into the intake through the pipe and creates an air curtain extending from the duct, and an eddying air stream separating the dust particles into larger dust particles and smaller dust particles and discharging the larger dust particles from a distal end of the second body of the intake and discharging smaller dust particles from the at least two air flow outlets of cyclone barrel of the cyclone barrel and thereafter into the at least two filters.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a dust collector in accordance with the first embodiment of the present invention.

FIG. 2 is an exploded perspective view of the dust collector shown in FIG. 1.

FIG. 3 is a cross-sectional view taken along line 3-3 of FIG. 1.

FIG. 4 illustrates the dust collector inducing air thereinto and creating an eddying air stream. Additionally, an air curtain is created, with the air curtain shown in phantom, and with the eddying air stream outside the air curtain shown in solid and inside the air curtain shown in phantom.

FIG. 5 is an extended view of FIG. 4 and shows larger dust particles and smaller dust particles entrained in the air stream are separated effectively.

FIG. 6 is an enlarged view of FIG. 5.

FIG. 7 is a cross-sectional view taken along 7-7 of FIG. 1.

FIG. 8 shows a second embodiment of a dust collector of the present invention.

FIG. 9 shows a third embodiment of a dust collector of the present invention.

### DETAILED DESCRIPTION OF THE PREFERRED EMBODIMENTS

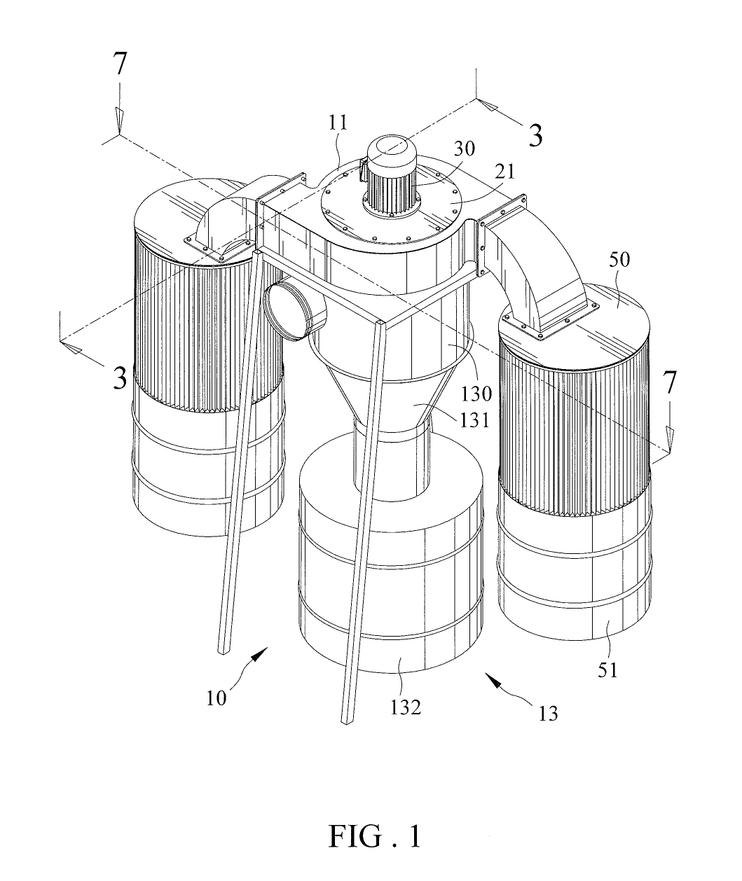

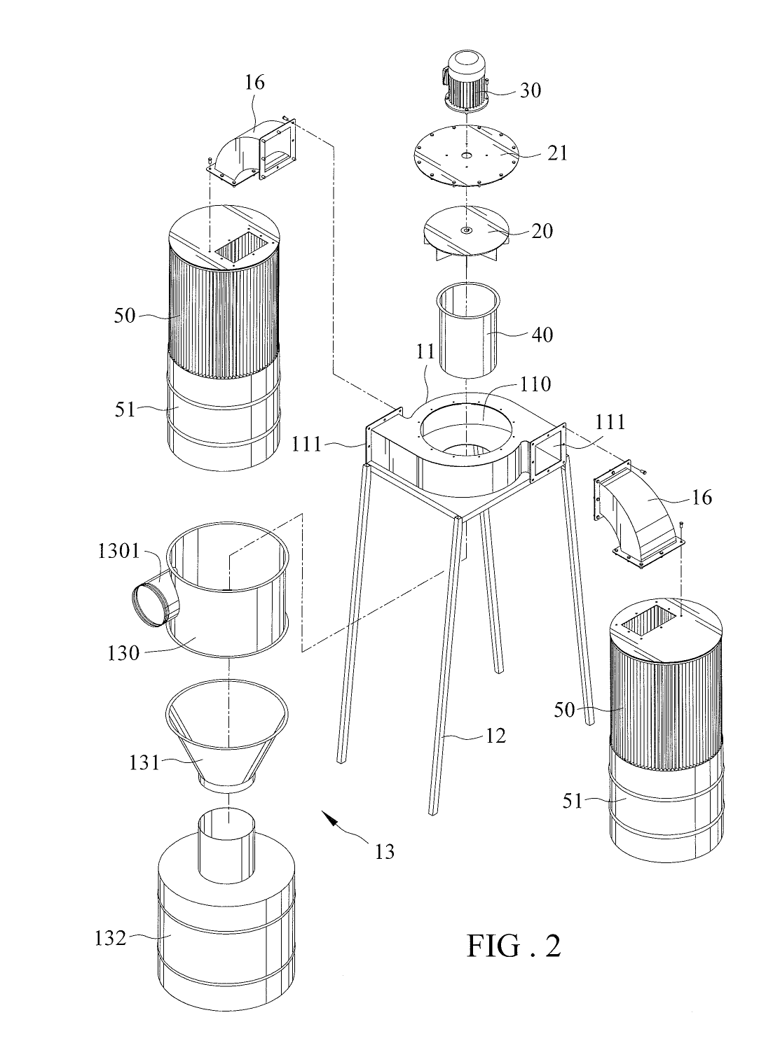

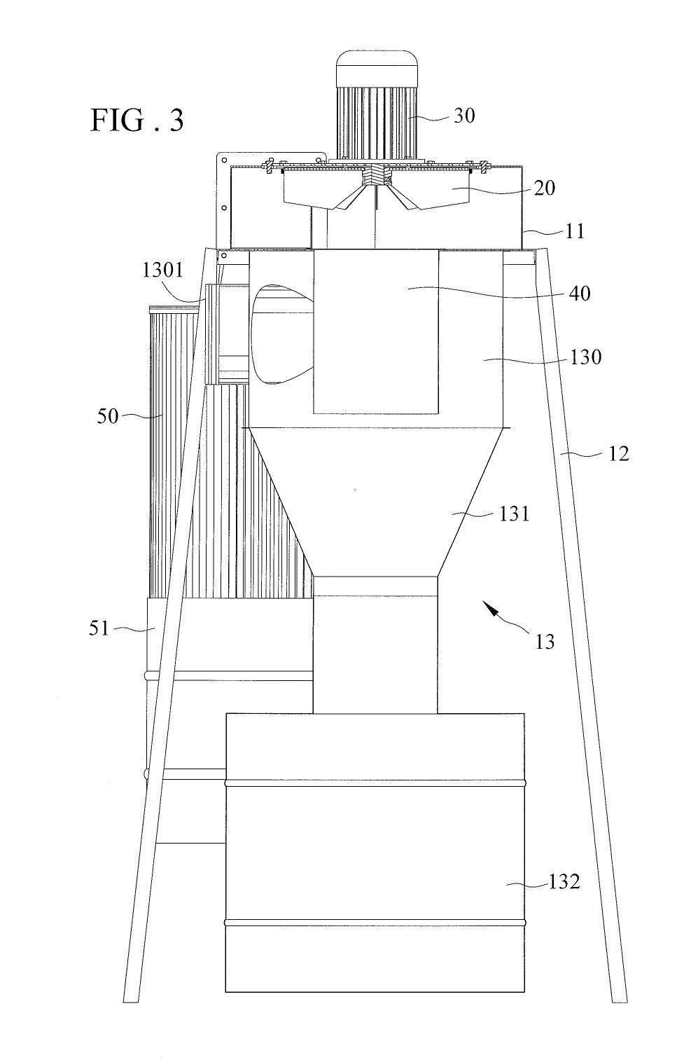

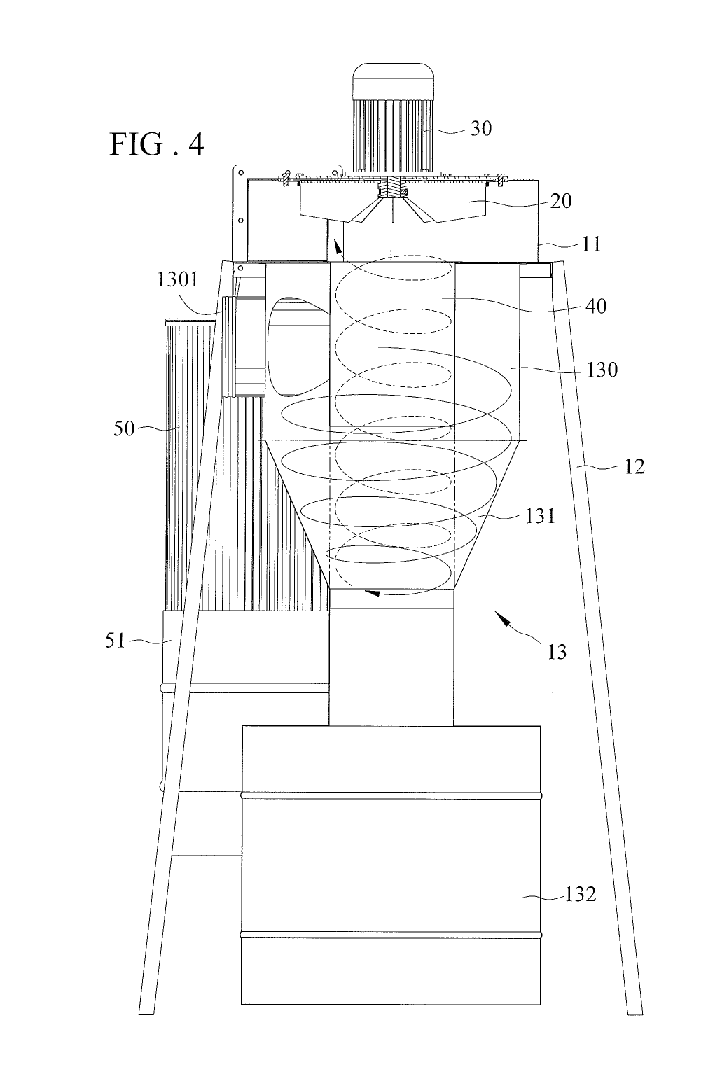

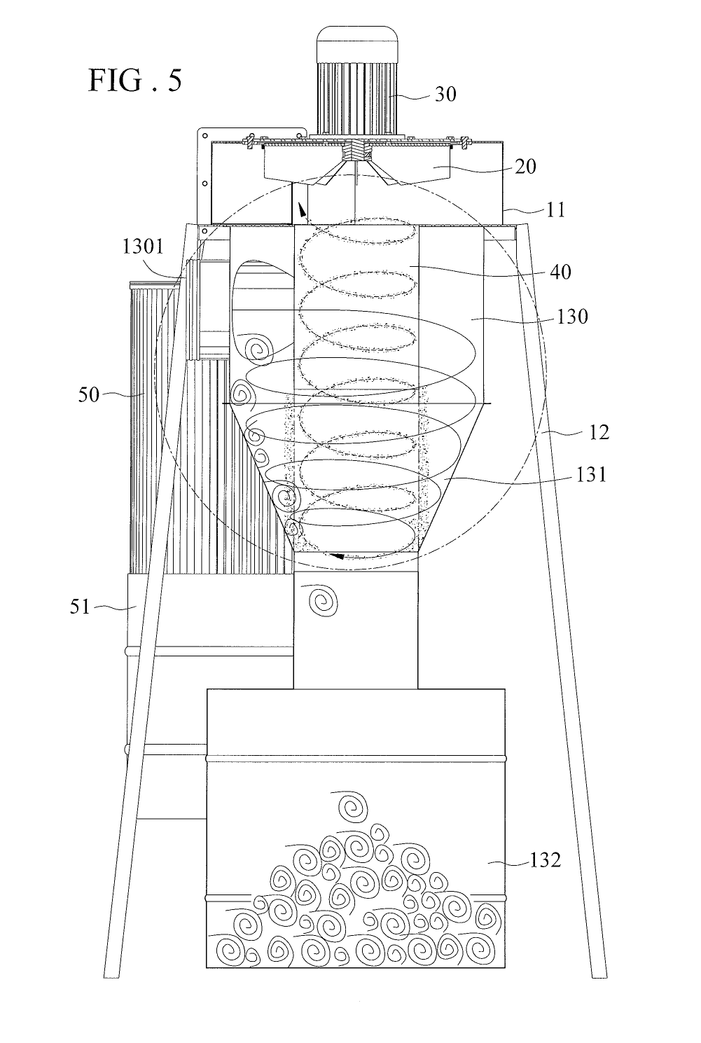

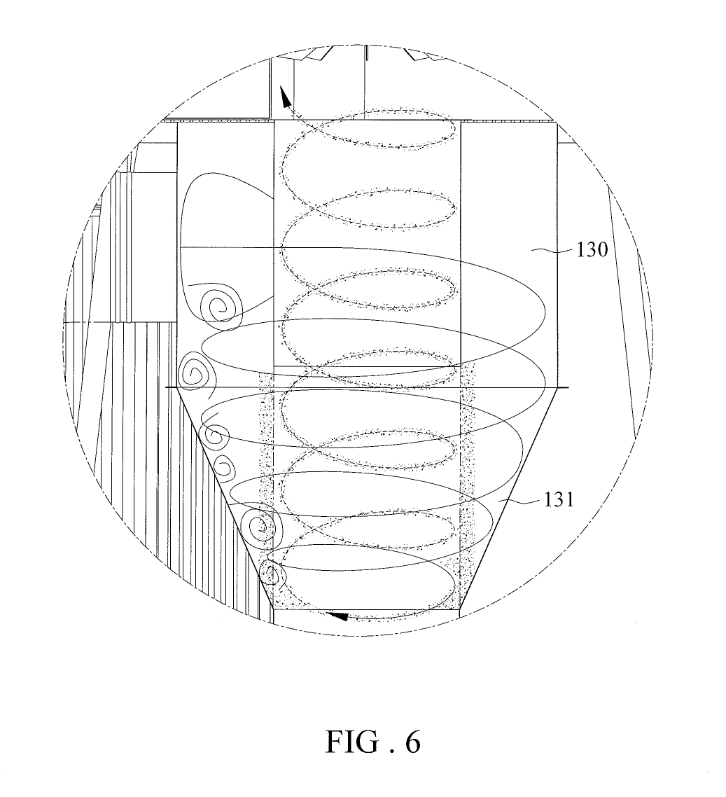

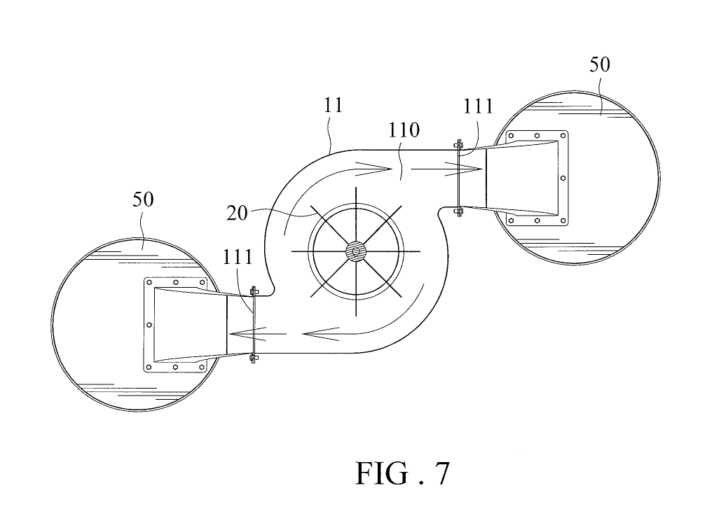

FIGS. 1 through 7 show a dust collector in accordance with a first embodiment of the present invention. The dust collector can effectively separate dust particles into larger dust particles and smaller dust particles (as shown in FIG. 5). It includes a separating chamber 10 in which larger dust particles are separated from smaller dust particles, an impeller 20 for causing an air stream to take dust particles outside the dust collector into the separating chamber 10, a motor 30 provided to drive the impeller 20, a duct 40 for enabling the impeller 20 to provide an air curtain that will play a major role in an effective separation of dust particles, and two filters 50 for collecting smaller dust particles.

The separating chamber 10 includes a cyclone barrel 11 including a chamber 110 defining a space and two openings defined on top side and bottom side thereof respectively, with the two openings extending in a first direction, and with the two air flow outlets 111 extending outwards therefrom in a plane transverse to the first direction and disposed in particular orientations. In the preferred embodiment, the two air flow outlets 111 extends tangentially from an outer peripheral wall of the chamber 110 and are disposed in opposite orientation. The separating chamber 10 may include a support stand 12 connectable with the cyclone barrel 11. The support stand 12 is adapted to stand on a supporting surface and to elevate the cyclone barrel 11 at a height from the supporting surface. The separating chamber 10 further includes an intake 13 including a first body 130 connected to and disposed under the cyclone barrel 11. The first body 130 of the intake 13 is hollow such that it includes a compartment extending longitudinally therethrough and delimited by an inner side of a peripheral wall thereof. The compartment of the intake 13 is connected to and in communication with the space of cyclone barrel 11 and has an internal diameter greater than an internal diameter of the opening on the bottom side of cyclone barrel 11. Additionally, the intake 13 includes a hollow pipe 1301 extending tangentially from the peripheral wall thereof and therethrough and therefore a space defined in the pipe 1301 is in communication with the compartment of intake 13. The intake 13 of the separating chamber 10 further includes a second body 131, which preferably in a form of a frustum but not limited, connected to and disposed under the first body 130 of the intake 13. Specifically, the second body 131 has an outer periphery being slanted and with a first distal end having a first diameter and a second distal end having a second diameter. The first diameter is larger than the second diameter. The first distal end of the second body 131 is joined to the first body 130 of the intake 13 Additionally, the second body 131 is hollow such that it includes a compartment extending from the first distal end to the second distal end and in communication with the compartment of intake 13. Further, a container 132 is connected to the second distal end of the second body 131. The container 132 is provided to collect larger dust particles exhausted from the second body 131.

The impeller 20 is mounted in the cyclone barrel 11, i.e. in the chamber 110, and disposed adjacent to the top side of the cyclone barrel 11 and includes a plurality of radially extended fins rotated about an axis upon the operation thereof, and therefore causing an air stream to take dust particles outside the dust collector into the separating chamber 10 through the pipe 1301 of intake 13. Specifically, the top side of the cyclone barrel 11 includes a lid 21 mounted thereon and the impeller 20 is mounted on a bottom side of the lid 21. Additionally, the lid 21 has an internal diameter greater than an internal diameter of the internal diameter of the opening on the top side of cyclone barrel 11, and therefore closing the opening. Preferably, the impeller 20 is disposed at a center of the cyclone barrel 11.

The motor 30 is connected to the impeller 20 in order to drive the impeller 20 and is mounted above the cyclone barrel 11. Preferably, the motor 30 is disposed at a center of the cyclone barrel 11. Preferably, the motor 30 is disposed outside the cyclone barrel 11 and mounted on a top side of the lid 21.

The duct 40 is connected to the bottom side of the cyclone barrel 11 and disposed within the compartment of intake 13. Additionally, the duct 40 is hollow such that it includes a compartment extending longitudinally therethrough. Preferably, the compartment of duct 40 has a uniform internal diameter.

The filters 50 are used to collect smaller dust particles exhausted from the air flow outlets 111 of cyclone barrel 11. Specifically, smaller dust particles exhausted from each air flow outlet 111 would be directed into one filter 50 by a conduit 16. The conduit 16 is connected between the air flow outlet 111 of cyclone barrel 11 and an entrance defined on the filter 50. Further, a container 51 is connected to and disposed under each filter 50 to collect smaller dust particles passing through the filter 50.

In view of the forgoing, the impeller 20 is driven by the motor 30 and as it operably moves dust particles outside the dust collector are adapted to be taken into the separating chamber 10 through the pipe 1301 of intake 13 and are separated into larger dust particles and smaller dust particles thereafter. Consequently, an eddying air stream is created upon the operational movement of the impeller 20 and dust particles are entrained in the air stream and taken from the compartment of the first body 130 of the intake 13 into the compartment of the second body 131 of the intake 13 and separated into larger dust particles and smaller dust particles by a centrifugal force generated by the air stream, wherein larger dust particles will stick close to an inner peripheral wall of the second body 131 of the intake 13 and smaller dust particles will stick close to an air curtain disposed at a center of the second body 131, with the air curtain created upon the operational movement of the impeller 20 and extending from the duct 40 to substantially the distal end of the second body 131 and having an external diametrical edge substantially the same as an external diametrical edge of the compartment of duct 40. After dust particles are separated, larger dust particles entrained in the air stream will move downwardly and along the inner peripheral wall the second body 131 and drop outside the second distal end thereof and collected by the container 132, and smaller particles entrained in the air stream will move downwardly and along the external diametrical edge of the air curtain and thereafter be brought within the confines of the air curtain and up and through the duct 40 and into the chamber 110 of cyclone barrel 11 by the air stream flowing inside the air curtain and duct 40. Smaller dust particles are then impelled out of the cyclone barrel 11 through the two air flow outlets 111 by the impeller 20 and passed through the filters 50 and collected by the containers 51. Furthermore, it is equally easy for smaller dust particles to get out of either of the two air flow outlets 111 because the impeller 20 is positioned at the center of the cyclone barrel 11. Additionally, since each filter 50 is positioned relatively lower than the cyclone barrel 11 smaller dust particles exhausted from the air flow outlets 111 are prevented from returning to cyclone barrel 11.

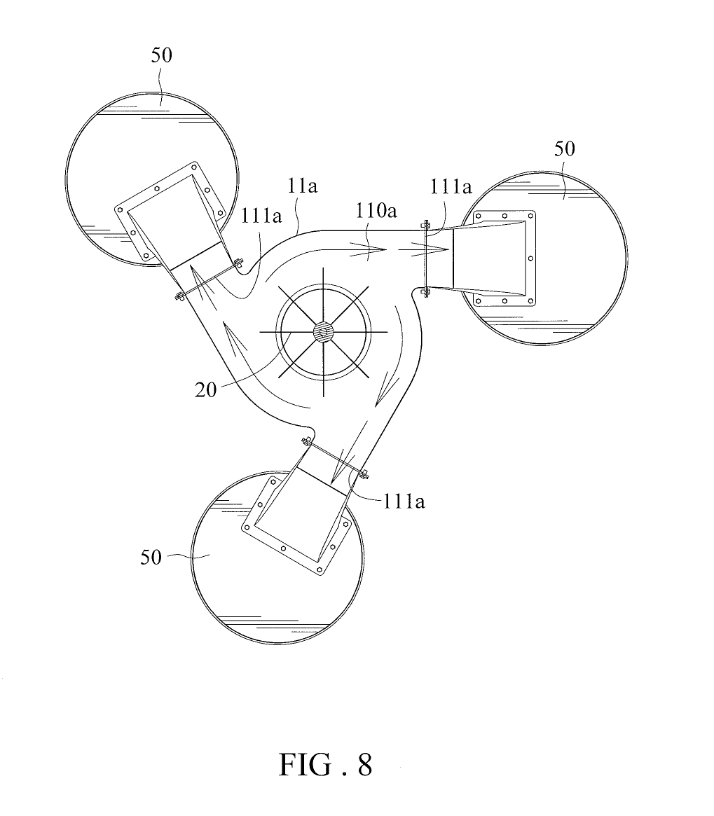

FIG. 8 shows a second embodiment of a dust collector of the present invention. The second embodiment differentiates from the first embodiment in that it includes a cyclone barrel 11 a including a chamber 110a and three air flow outlets 111a extending outwards and tangentially from an outer peripheral wall of the chamber 110a.

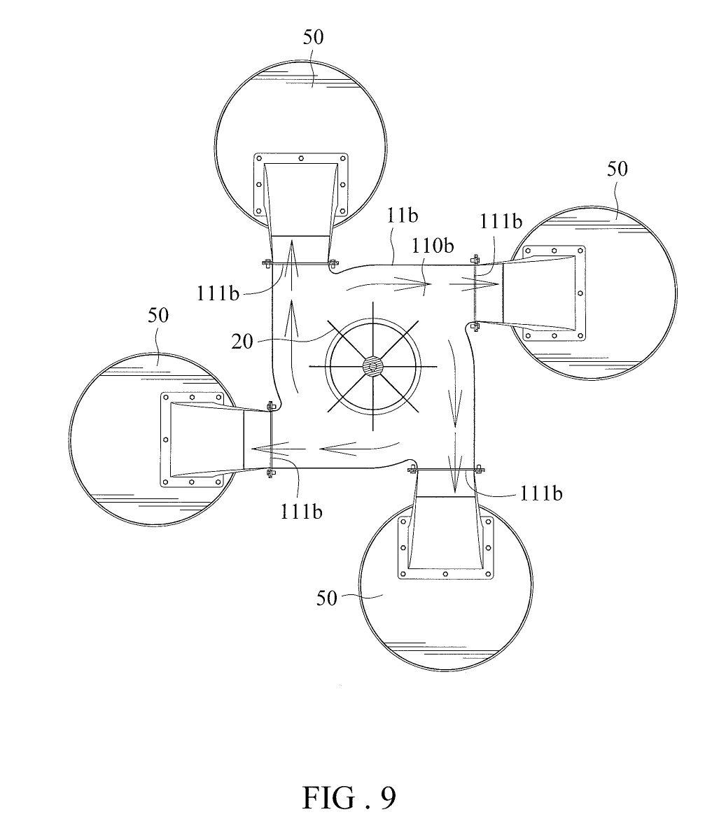

FIG. 9 shows a third embodiment of a dust collector of the present invention. The third embodiment differentiates from the first embodiment in that it includes a cyclone barrel 11b including a chamber 110b and four air flow outlets 111b extending outwards and tangentially from an outer peripheral wall of the chamber 110b.

Therefore, each of the embodiments includes at least two air flow outlets 111, 111a, and 111b disposed in particular orientations and extending tangentially from the associated chamber 110, 110a, and 110b of the cyclone barrel 11, 11a, and 11b in order to prevent dust particles clogging their way of travel in the dust collector. Furthermore, the impeller 20 creates an eddying air stream in the separating chamber 10 and the duct 40 disposed with the intake 13 of separating chamber 10, and that effectively separates dust particles into larger dust particles and smaller dust particles.

While the specific embodiments have been illustrated and described, numerous modifications come to mind without significantly departing from the spirit of invention, and the scope of invention is only limited by the scope of the accompanying claims.

What is claimed is:

1. A dust collector comprising:
a separating chamber including a cyclone barrel which includes a chamber defining a space, and at least two air flow outlets extending tangentially from an outer peripheral wall of the chamber, a hollow intake including a first body connected to and disposed under the cyclone barrel and including a first compartment extending longitudinally therethrough and a hollow pipe extending tangentially from a peripheral wall of the first body, and a second body connected to and disposed under the first body and including a second compartment extending longitudinally therethrough;
an impeller mounted in the chamber of cyclone barrel and including a radially extended fin rotated about an axis upon the operation thereof;
a motor mounted above the cyclone barrel and connected to the impeller for driving the impeller;
a duct connected to a bottom side of the cyclone barrel and disposed within the first compartment of the first body of the intake and including a third compartment extending longitudinally therethrough; and
at least two filters connected to the at least two air flow outlets, respectively; and
wherein the space of cyclone barrel, the first compartment of the first body of the intake, and the second compartment of cyclone chamber communicate with one another; and
wherein the operational movement of the impellor induces dust particles into the intake through the pipe and creates an air curtain extending from the duct, and an eddying air stream separating the dust particles into larger dust particles and smaller dust particles and discharging the larger dust particles from a distal end of the second body of the intake and discharging smaller dust particles from the at least two air flow outlets of cyclone barrel and thereafter into the at least two filters.

2. The dust collector as claimed in claim 1, wherein each filter is positioned relative lower than the cyclone barrel such that smaller dust particles exhausted from the air flow outlets are prevented from returning to cyclone barrel.

3. The dust collector as claimed in claim 1, wherein the chamber of cyclone barrel includes first opening and second opening defined on top side and bottom side thereof respectively, with the first and second openings extending in a first direction, and wherein the at least two air flow outlets extend outwards therefrom in a plane transverse to the first direction.

4. The dust collector as claimed in claim 1 further comprising a support stand connectable with the cyclone barrel, with the support adapted to stand on a supporting surface and to elevate the cyclone barrel at a height from the supporting surface.

5. The dust collector as claimed in claim 1 further comprising a first container connected to the second body of the intake to collect the larger dust particles exhausted from the second body of the intake, and at least two second containers connected to the at least two filters, respectively, to collect smaller dust particles passed through the at least two filters.

6. The dust collector as claimed in claim 3 further comprising a lid mounted on the top side of the cyclone barrel and closing the first opening on the top side, with the lid including an internal diameter greater than an internal diameter of the first opening, and wherein the impeller is mounted on a bottom side of the lid.

7. The dust collector as claimed in claim 1, wherein the duct is disposed at a center of the cyclone chamber.

8. The dust collector as claimed in claim 1, wherein the motor is disposed at a center of the cyclone barrel.

9. The dust collector as claimed in claim 1, wherein the impeller is disposed at a center of the cyclone barrel.

10. The dust collector as claimed in claim 1, wherein the third compartment of duct has a uniform internal diameter.

11. The dust collector as claimed in claim 1, wherein the second body of the intake including a first distal end and a second distal end and extending from the first distal end to the second distal end, and wherein the second body includes an outer periphery in a form of a frustum, with the second body including a first diameter at the first distal end and a second diameter at the second distal end, and with the first diameter being greater than the second diameter.
